(19) United States
(12) Patent Application Publication
(10) Pub. No.: US 2026/0219909 A1
(43) Pub. Date: Jul. 30, 2026

(54) AUTOMATED CONTROL OF MACHINE IMAGE LIFECYCLE MANAGEMENT

(71) Applicant: Capital One Services, LLC, McLean, VA (US)

(72) Inventors: Vikas VIJAY, Glen Allen, VA (US); Parth PATEL, Frederick, MD (US)

(21) Appl. No.: 19/036,872

(22) Filed: Jan. 24, 2025

(51) Int. Cl. G06F 9/455

(52) U.S. Cl. CPC G06F 9/45558; G06F 2009/45575; G06F 2009/45591

(57) ABSTRACT

In some implementations, a system may determine, based on respective reference information associated with a set of one or more machine images of a plurality of machine images associated with a cloud computing environment, respective lifecycle management actions for the set of one or more machine images. The system may cause the respective lifecycle management actions to be performed for the set of one or more machine images.

### BACKGROUND

Cloud-based computing environments can facilitate the use of virtual machines. A virtual machine is a virtual instance that can operate using a machine image. A cloud-based computing environment can manage one or more accounts to distribute or otherwise make available machine images to virtual machines associated with the one or more accounts.

### SUMMARY

In some implementations, a system for machine image lifecycle management includes one or more memories, and one or more processors, communicatively coupled to the one or more memories, configured to: identify a plurality of machine images associated with a cloud computing environment; determine, using at least one of one or more filter parameters or respective tag information associated with the plurality of machine images, a set of one or more machine images of the plurality of machine images; determine, based on respective reference information associated with the set of one or more machine images, respective lifecycle management actions for the set of one or more machine images; and cause the respective lifecycle management actions to be performed for the set of one or more machine images.

In some implementations, a non-transitory computer-readable medium storing a set of instructions includes one or more instructions that, when executed by one or more processors of a system, cause the system to: determine, using at least one of one or more filter parameters or respective tag information associated with a plurality of machine images associated with a cloud computing environment, a set of one or more machine images of the plurality of machine images; determine, based on respective reference information associated with the set of one or more machine images, respective lifecycle management actions for the set of one or more machine images; and cause the respective lifecycle management actions to be performed for the set of one or more machine images.

In some implementations, a method includes determining, by a system and based on respective reference information associated with a set of one or more machine images of a plurality of machine images associated with a cloud computing environment, respective lifecycle management actions for the set of one or more machine images; and causing, by the system, the respective lifecycle management actions to be performed for the set of one or more machine images.

### BRIEF DESCRIPTION OF THE DRAWINGS

FIGS. 1A and 1B are diagrams of an example associated with automated control of machine image lifecycle management, in accordance with some embodiments of the present disclosure.

FIG. 2 is a diagram of an example environment in which systems and/or methods described herein may be implemented, in accordance with some embodiments of the present disclosure.

FIG. 3 is a diagram of example components of a device associated with automated control of machine image lifecycle management, in accordance with some embodiments of the present disclosure.

FIG. 4 is a flowchart of an example process associated with automated control of machine image lifecycle management, in accordance with some embodiments of the present disclosure.

### DETAILED DESCRIPTION

The following detailed description of example implementations refers to the accompanying drawings. The same reference numbers in different drawings may identify the same or similar elements.

In cloud computing environments, instances, also referred to as virtual machines, can operate using a machine image. A machine image can include files or other information used as part of executing the instance. For example, a machine image may include an operating system for the instance. Some organizations deploy and manage multiple machine images across multiple compute resources. Compute resources can include physical and/or virtual infrastructure elements of a cloud computing environment, such as dynamic groups of instances (e.g., autoscaling groups), batch processes, and/or servers, along with other examples.

However, as an organization deploys newer machine images, some machine images may become outdated. These outdated machine images can “pile up” and consume overhead, such as storage space (e.g., associated with a cloud computing environment that hosts the outdated machine images). Further, in many cases, the outdated machine images fail to conform to updated security protocols, and thus pose a security risk to the cloud computing environment.

In some cases, outdated machine images can be manually retired. For example, an administrator (e.g., of the cloud computing environment) can decide to deregister and/or deprecate a machine image, such as when the machine image is older than a threshold age. However, such a manual process increases a likelihood of mistakenly identifying and removing a machine image that is referenced by and utilized by an active instance, which can compromise execution of the active instance and can reduce a stability of the cloud computing environment.

Some implementations described herein enable automated control of machine image lifecycle management. For example, some implementations include a lifecycle management system that identifies a plurality of machine images associated with a cloud computing environment. The lifecycle management system then determines a set of one or more machine images (e.g., a subset of the plurality of machine images) that may be candidates for lifecycle management actions, as described herein. For example, the lifecycle management system may filter the plurality of machine images, using one or more filter parameters and/or tag information associated with the plurality of machine images, to determine the set of one or more machine images.

The lifecycle management system may then determine respective lifecycle management actions for the set of one or more machine images, such as by using respective reference information associated with the set of one or more machine images. For example, when the lifecycle management system determines (e.g., based on reference information associated with a particular machine image) that the particular machine image is actively used by at least one compute resource (e.g., one or more instances and/or batch processes, along with other examples), then the lifecycle management system may determine that a deprecation lifecycle management action or an access revocation lifecycle management action, as further described herein, is to be performed for the particular machine image. Alternatively, when the lifecycle management system determines that the particular machine image is not actively used by at least one compute resource (e.g., based on reference information associated with the particular machine image), then the lifecycle management system may determine that a deregistration lifecycle management action, as further described herein, is to be performed for the particular machine image.

As a result, in some implementations, the lifecycle management system identifies machine images that warrant performance of a lifecycle management action (e.g., an action to deprecate, deregister, or revoke access to) and automatically causes performance of lifecycle management actions for the machine images. For example, by filtering machine images using dynamic filter parameters and/or tag information, the system may automatically identify and deregister unused machine images. By deregistering these unused machine images, the system reduces unnecessary use or allocation of storage or other computing resources (e.g., processing resources, memory resources, communication resources, and/or power resources, along with other examples) to maintain the unused machine image. Accordingly, this allows computing resources, that would otherwise be used to maintain the unused machine images, to maintain and support machine images that are actively used by compute resources of the cloud computing environment, which improves respective performances of the compute resources, as well as other resources of the cloud computing environment. As another example, by filtering machine images using dynamic filter parameters and/or tag information, the system may automatically identify and deprecate or otherwise revoke access (e.g., present or future access by other compute resources) to outdated machine images (that are still actively used by compute resources of the cloud computing environment). By deprecating or otherwise revoking access to these outdated machine images, the lifecycle management system increases a stability of the cloud computing environment, such as by allowing the compute resources that are still actively using the compute resources to continue using the outdated machine images, while increasing a likelihood that the outdated machine images will eventually cease to be actively used and therefore able to be deregistered in the future (e.g., when the compute resources cease to operate).

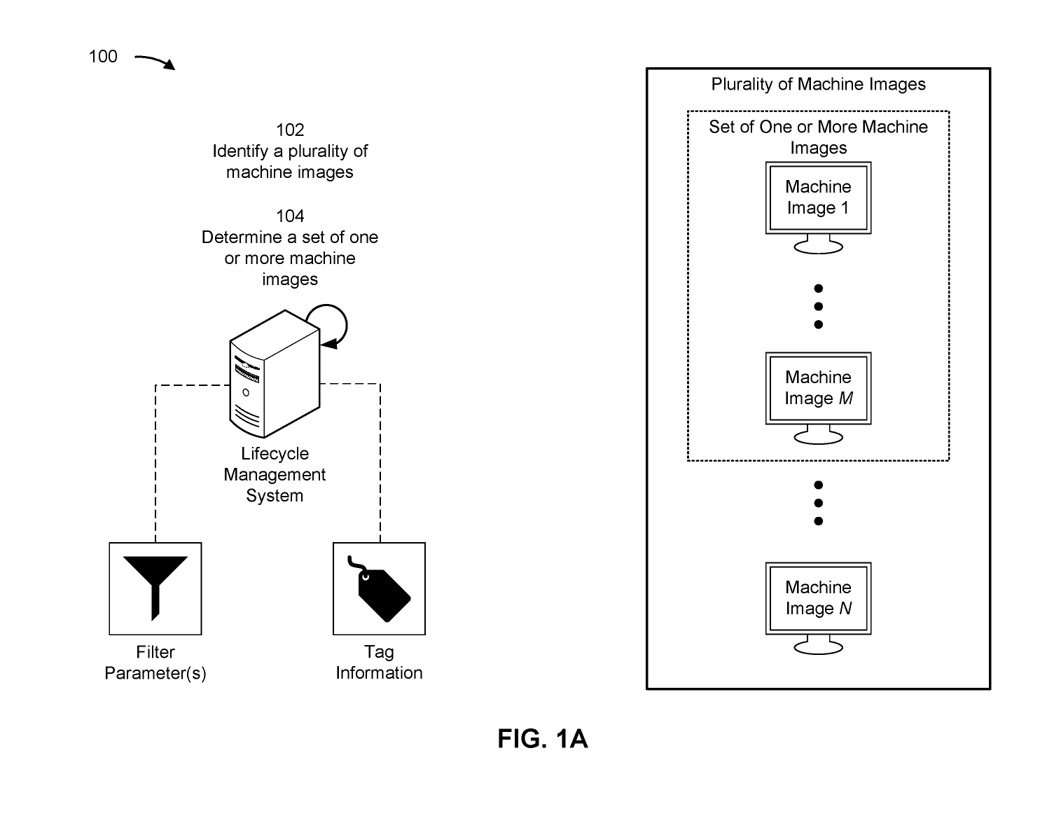

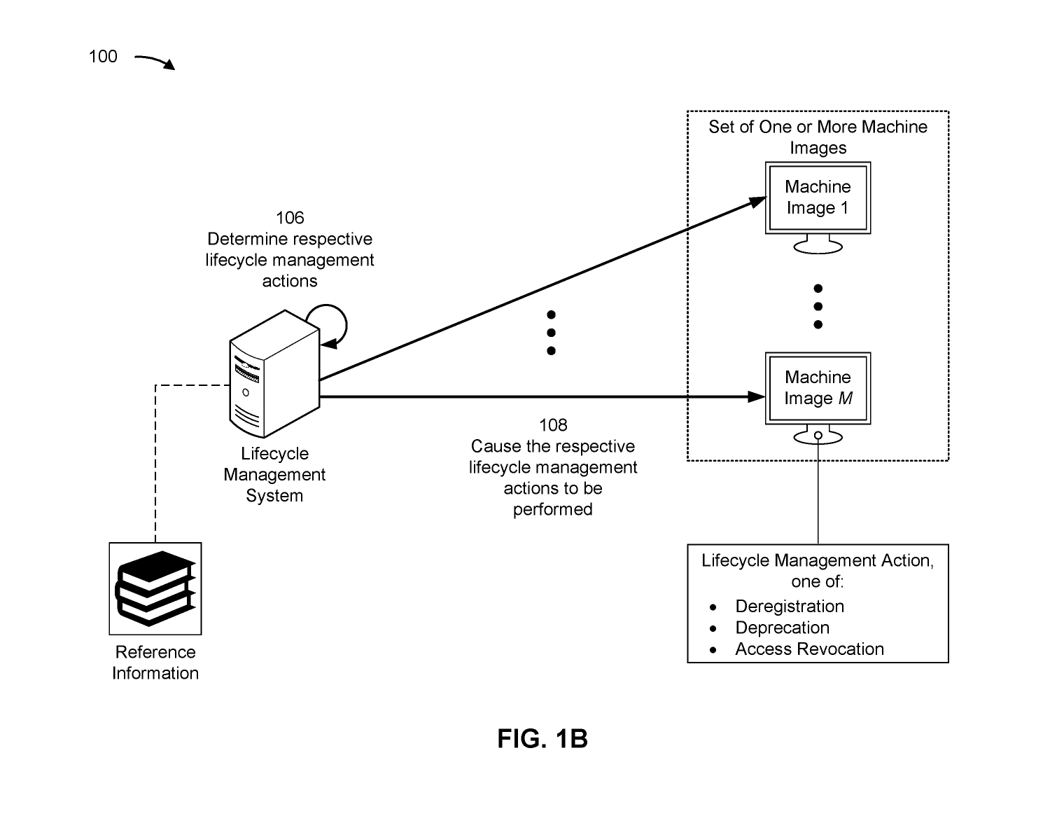

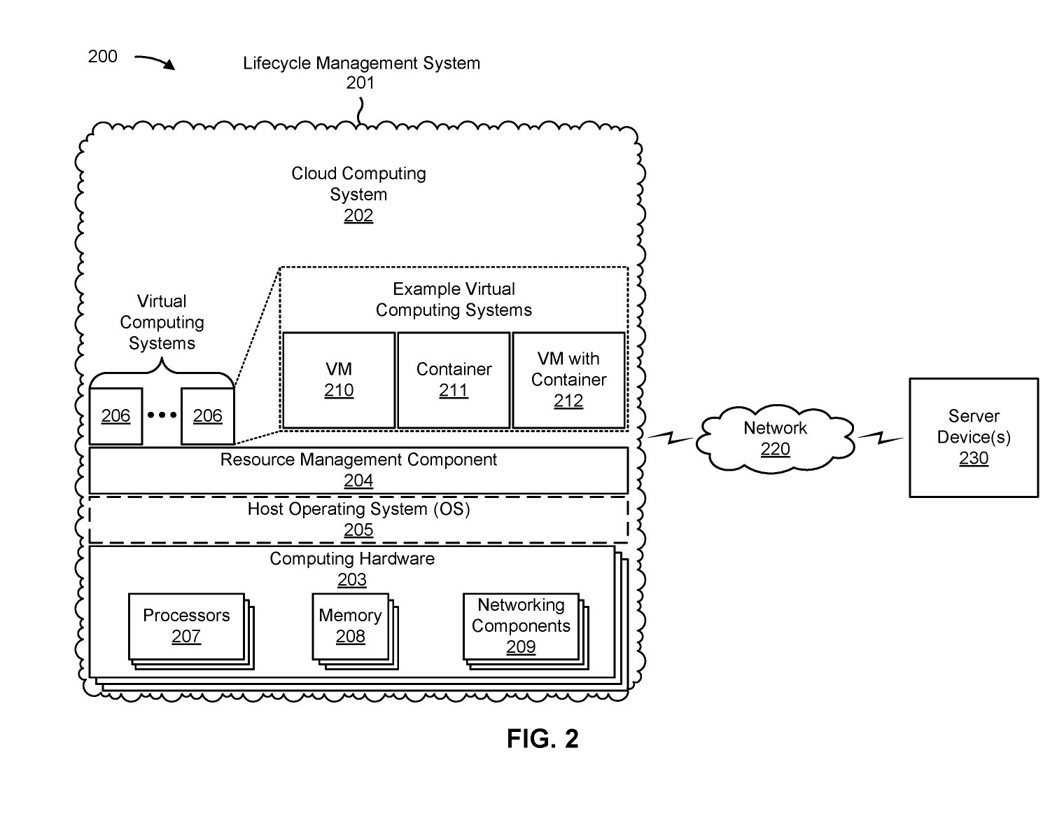

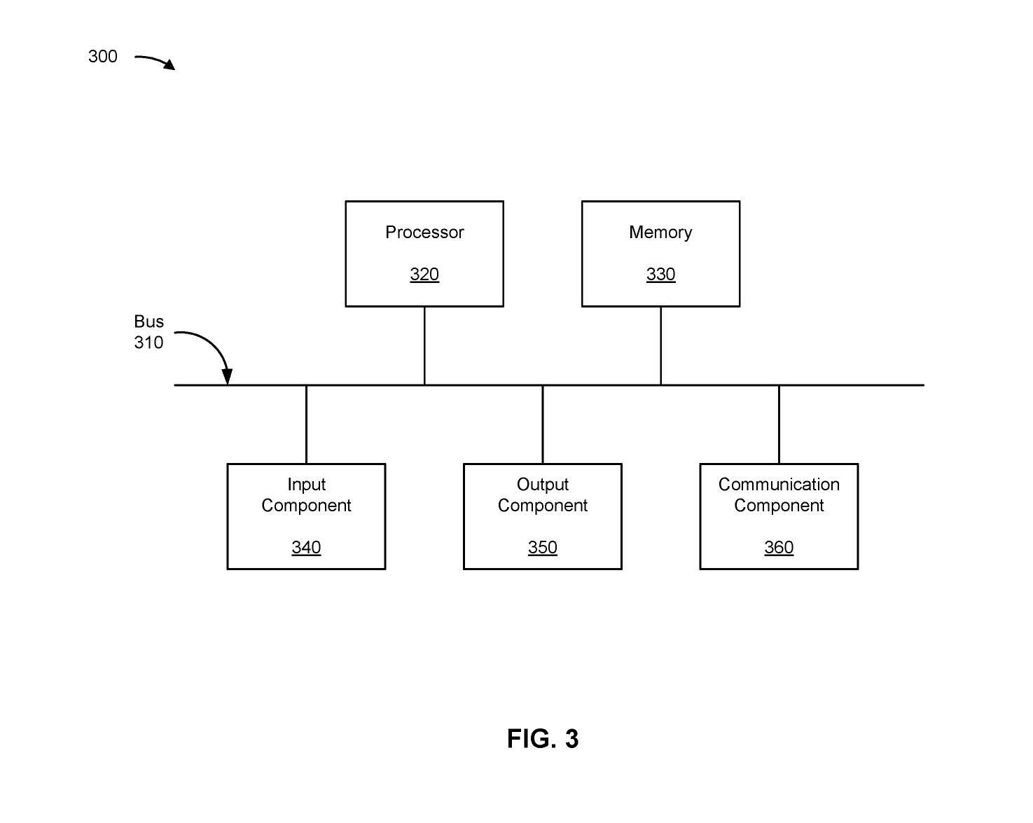

FIGS. 1A and 1B are diagrams of an example 100 associated with automated control of machine image lifecycle management. As shown in FIGS. 1A and 1B, example 100 includes a lifecycle management system and a plurality of machine images (e.g., a machine image 1 through a machine image N, where N is greater than one), which are described in more detail in connection with FIGS. 2 and 3.

As shown in FIGS. 1A-1B, the lifecycle management system may determine lifecycle management actions for machine images associated with a cloud computing environment (e.g., within a cloud architecture provided by the cloud service). The lifecycle management system may initiate performance of one or more operations described herein in relation to FIGS. 1A-1B according to a periodic schedule. For example, the lifecycle management system may initiate performance of the one or more operations after a duration (e.g., a period) has elapsed (e.g., from a particular event, such as a completion of a prior performance of the one or more operations), and/or may initiate performance of the one or more operations at a defined time and/or date (e.g., once per day, once per week, once per month, along with other examples). Additionally, or alternatively, the lifecycle management system may initiate performance of the one or more operations based on, in response to, or otherwise in association with detection of a trigger event. A trigger event may include a creation and/or a deployment of one or more or new machine images, a user input (e.g., an input to the lifecycle management system), and/or a resource condition of the lifecycle management system being satisfied (e.g., an amount of storage resources used by the lifecycle management system satisfying a threshold).

As shown by reference number 102, the lifecycle management system may identify the plurality of machine images associated with the cloud computing environment. In some implementations, the cloud computing environment may be associated with a plurality of accounts (e.g., provide respective computing resources for the plurality of accounts). In some examples, the plurality of machine images may include machine images associated with a subset of the plurality of accounts of the cloud service. Alternatively, the plurality of images may include machine images associated with each account of the cloud service. The lifecycle management system may identify the plurality of machine images by communicating with a data structure (e.g., that is included in the lifecycle management system and/or is accessible to the lifecycle management system) that stores information related to the cloud computing environment and/or the plurality of accounts of the cloud computing environment.

As shown by reference number 104, the lifecycle management system may determine a set of one or more machine images (e.g., a subset of the plurality of machine images, such as machine image 1 through a machine image M, where M is greater than or equal to one and less than or equal to N). The set of one or more machine images may be machine images for which the lifecycle management system is to perform respective lifecycle management actions, as further described herein. The lifecycle management system may determine the set of one or more machine images using one or more filter parameters and/or tag information associated with the plurality of machine images, as further described herein.

Each machine image, of the plurality of machine images, may include, or may have, one or more attributes. An attribute may indicate a characteristic, a property, or other information associated with the machine image. For example, an attribute may indicate a time-based property of the machine image (e.g., a date and/or time associated with creation or modification of the machine image), a size of the machine image (e.g., in terms of kilobytes, megabytes, gigabytes, along with other examples), and/or a type of the machine image (e.g., a fundamental machine image, an incremental machine image, a differential machine image, along with other examples).

The one or more filter parameters may be defined via a configuration file (e.g., a user-generated and/or maintained configuration file), user input (e.g., via a graphical user interface (GUI) or other interface, or other sources. A filter parameter, of the one or more filter parameters, may correspond to at least one attribute of a machine image. For example, a time-based filter parameter may correspond to a time-based attribute of a machine image, a size filter parameter may correspond to a size attribute of the machine image, and so on. Each filter parameter may be a criterion, where satisfaction of the criterion can be used to facilitate selection of a machine image as part of the set of one or more machine images. For example, a time-based filter parameter may be satisfied when a time and/or date indicated by a time-based attribute of the machine attribute is the same as, or predates, a time and/or date indicated by the time-based filter parameter.

In some implementations, the lifecycle management system may determine the set of one or more machine images by determining that each machine image, that is to be included in the set of one or more machine images, has one or more attributes that satisfy the one or more filter parameters.

In some implementations, the lifecycle management system may identify a particular machine image, of the plurality of machine images, and may identify one or more attributes associated with the particular machine image. Accordingly, the lifecycle management system may cause (e.g., based on the one or more filter parameters and the one or more attributes) the particular image to be included in the set of one or more machine images, or, alternatively, to be not included in the set of one or more machine images. For example, the lifecycle management system may determine that the one or more attributes satisfy the one or more filter parameters (e.g., satisfy each filter parameter of the one or more filter parameters) and may thereby cause the particular image to be included in the set of one or more machine images. As another example, the lifecycle management system may determine that the one or more attributes do not satisfy the one or more filter parameters (e.g., at least one filter parameter of the one or more filter parameters is not satisfied) and may thereby cause the particular image to be not included in the set of one or more machine images.

In some implementations, tag information for a machine image may be information indicating special handling of the machine image, such as by indicating one or more indications for the machine image (e.g., that override whether the one or more filter parameters are satisfied). For example, tag information may indicate that a machine image is to be included in the set of one or more machine images, despite attributes of the machine image not satisfying the one or more filter parameters. Alternatively, tag information may indicate that a machine image is not to be included in the set of one or more machine images, despite attributes of the machine image satisfying the one or more filter parameters.

In some implementations, the lifecycle management system may identify a particular machine image, of the plurality of machine images, and may identify particular tag information that is associated with the particular machine image. Accordingly, the lifecycle management system may cause (e.g., based on the particular tag information) the particular image to be included in the set of one or more machine images, or, alternatively, to be not included in the set of one or more machine images. For example, the lifecycle management system may determine, based on the particular tag information indicating that the particular machine is to be included in the set of one or more machine images, that the particular machine is to be included in the set of one or more machine images and may thereby cause the particular image to be included in the set of one or more machine images. As another example, the lifecycle management system may determine, based on the particular tag information indicating that the particular machine is to be not included in the set of one or more machine images, that the particular machine is to be not included in the set of one or more machine images and may thereby cause the particular image to be not included in the set of one or more machine images.

In some implementations, tag information for a machine image may be information indicating additional and/or modified criteria for whether the particular machine image is to be included in the set of one or more machine images. Said another way, tag information for a machine image may modify the one or more filter parameters for the machine image. By way of example, tag information for a particular machine image may indicate that the particular machine image is not to be deprecated until at least 90 days after creation, while the one or more filter parameters may indicate that a machine image is to be included in the set of one or more machine images when the machine image is older than 60 days. In such an example, the lifecycle management system may modify the one or more filter parameters for the particular machine image to indicate that the particular machine image is to be included in the set of one or more machine images when the particular machine image is older than 90 days.

In some implementations, the lifecycle management system may identify a particular machine image, of the plurality of machine images, and may identify particular tag information that is associated with the particular machine image. The lifecycle management system then may modify, based on the particular tag information, the one or more filter parameters (e.g., as described above). The lifecycle management system then may identify one or more attributes associated with the particular machine image. Accordingly, the lifecycle management system may cause (e.g., based on the modified one or more filter parameters and the one or more attributes) the particular image to be included in the set of one or more machine images or, alternatively, to be not included in the set of one or more machine images. For example, the lifecycle management system may determine that the one or more attributes satisfy the modified one or more filter parameters (e.g., satisfy each filter parameter of the modified one or more filter parameters) and may thereby cause the particular image to be included in the set of one or more machine images. As another example, the lifecycle management system may determine that the one or more attributes do not satisfy the modified one or more filter parameters (e.g., at least one filter parameter of the modified one or more filter parameters is not satisfied) and may thereby cause the particular image to be not included in the set of one or more machine images.

Accordingly, determining the set of one or more machine images may include determining whether attributes of a particular machine image satisfy the filter parameters and/or filter parameters modified by tag information of the particular machine image. Said another way, determining the set of one or more machine images may include filtering the plurality of machine images using the filter parameters and the tag information. For example, if one or more attributes of the particular machine image satisfy the filter parameters, then the lifecycle management system may include the particular image in the set of one or more machine images. Alternatively, if the one or more attributes of the particular machine image do not satisfy the filter parameters, then the lifecycle management system may not include the particular image in the set of one or more machine images.

In some implementations, the lifecycle management system may use a serverless compute function, such as a lambda function, to determine the set of one or more machine images. For example, the lifecycle management system may provide the one or more filter parameters and/or the tag information as an input to the serverless compute function. Based on, in response to, or otherwise associated with obtaining the one or more filter parameters and/or the tag information, the serverless compute function may determine the set of one or more machine images.

As shown in FIG. 1B, and by reference number 106, the lifecycle management system may determine respective lifecycle management actions for the set of one or more machine images. Each lifecycle management action, of the respective lifecycle management actions, may include, for example, one of a deregistration lifecycle management action, a deprecation lifecycle management action, or an access revocation lifecycle management action, as further described herein.

In some implementations, the lifecycle management system may determine the respective lifecycle management actions for the set of one or more machine images using respective reference information for the set of one or more machine images. Reference information for a particular machine image may be information indicating whether the particular machine image is used by at least one compute resource of the cloud computing environment (e.g., whether the particular machine image is referenced by at least one instance, at least one batch process, and/or at least one autoscaling group, along with other examples). Said another way, reference information may indicate whether a particular machine image is actively used by at least one compute resource of the cloud computing environment.

Accordingly, to determine the respective lifecycle management actions for the set of one or more machine images, the lifecycle management system may identify a particular machine image of the set of one or more machine images and may identify particular reference information that is associated with the particular machine image. The lifecycle management system then may determine, based on the particular reference information, whether the particular machine image is actively used by at least one compute resource of the cloud service. Accordingly, the lifecycle management system may determine (e.g., based on determining whether the particular machine image is actively used) a particular lifecycle management action, of the respective lifecycle management actions, for the particular machine image.

A lifecycle management action may include one of a deregistration lifecycle management action, a deprecation lifecycle management action, or an access revocation lifecycle management action. To perform a deregistration lifecycle management action on a machine image, the lifecycle management system may delete the machine image, such as removing the machine image from a machine image registry associated with the cloud computing environment. By performing a deregistration lifecycle management action, the lifecycle management system may reduce the storage overhead associated with storing machine images in the cloud computing environment.

To perform a deprecation lifecycle management action on a machine image, the lifecycle management system may store an indication that the machine image is deprecated (e.g., may mark the machine image as deprecated). A deprecated machine image may continue to be used by currently active compute resources, but new compute resources may not reference the deprecated machine image. To perform an access revocation lifecycle management action on a machine image, the lifecycle management system may not allow the machine image to be shared to one or more user accounts. For example, user accounts that currently execute compute resources which use the machine image may continue to use the machine image. However, the lifecycle management system may not allow the machine image to be shared (e.g., copied) to additional user accounts. By performing a deprecation and/or an access revocation lifecycle management action on a machine image, the lifecycle management system may maintain system stability by allowing currently active compute resources to use the machine image, while increasing the likelihood that the machine image will be deregistered in the future (e.g., as the currently active compute resources are retired).

When the lifecycle management system determines that a particular machine image is actively used by at least one compute resource, the lifecycle management system may determine that a deprecation lifecycle management action or an access revocation lifecycle management action is to be performed for the particular machine image. Alternatively, when the lifecycle management system determines that the particular machine image is not actively used by at least one compute resource, then the lifecycle management system may determine that a deregistration lifecycle management action is to be performed for the particular machine image.

As shown by reference number 108, the lifecycle management system may cause the respective lifecycle management actions to be performed for the set of one or more machine images. In some examples, the lifecycle management system may perform the respective lifecycle management actions. Additionally, or alternatively, the lifecycle management system may cause another device or group of devices to perform all or a portion of the respective lifecycle management actions. For example, the lifecycle management system may send one or more commands to a server device to cause the server device to cause at least some of the respective lifecycle management actions to be performed.

As indicated above, FIGS. 1A and 1B are provided as an example. Other examples may differ from what is described with regard to FIGS. 1A and 1B.

FIG. 2 is a diagram of an example environment 200 in which systems and/or methods described herein may be implemented. As shown in FIG. 2, environment 200 may include a lifecycle management system 201, which may include one or more elements of and/or may execute within a cloud computing system 202. The cloud computing system 202 may include one or more elements 203-212, as described in more detail below. As further shown in FIG. 2, environment 200 may include a network 220 and/or one or more server devices 230. Devices and/or elements of environment 200 may interconnect via wired connections and/or wireless connections.

The cloud computing system 202 may include computing hardware 203, a resource management component 204, a host operating system (OS) 205, and/or one or more virtual computing systems 206, which may be examples of virtual machines and/or instances. The cloud computing system 202 may execute on, for example, an Amazon Web Services platform, a Microsoft Azure platform, or a Snowflake platform. The resource management component 204 may perform virtualization (e.g., abstraction) of computing hardware 203, for example using one or more machine images, to create the one or more virtual computing systems 206. Using virtualization, the resource management component 204 enables a single computing device (e.g., a computer or a server) to operate like multiple computing devices, such as by creating multiple isolated virtual computing systems 206 from computing hardware 203 of the single computing device. In this way, computing hardware 203 can operate more efficiently, with lower power consumption, higher reliability, higher availability, higher utilization, greater flexibility, and lower cost than using separate computing devices.

The computing hardware 203 may include hardware and corresponding resources from one or more computing devices. For example, computing hardware 203 may include hardware from a single computing device (e.g., a single server) or from multiple computing devices (e.g., multiple servers), such as multiple computing devices in one or more data centers. As shown, computing hardware 203 may include one or more processors 207, one or more memories 208, and/or one or more networking components 209. Examples of a processor, a memory, and a networking component (e.g., a communication component) are described elsewhere herein.

The resource management component 204 may include a virtualization application (e.g., executing on hardware, such as computing hardware 203) capable of virtualizing computing hardware 203 to start, stop, and/or manage one or more virtual computing systems 206. For example, the resource management component 204 may include a hypervisor (e.g., a bare-metal or Type 1 hypervisor, a hosted or Type 2 hypervisor, or another type of hypervisor) or a virtual machine monitor, such as when the virtual computing systems 206 are virtual machines 210. Additionally, or alternatively, the resource management component 204 may include a container manager, such as when the virtual computing systems 206 are containers 211. In some implementations, the resource management component 204 executes within and/or in coordination with a host operating system 205.

A virtual computing system 206 may include a virtual environment that enables cloud-based execution of operations and/or processes described herein using computing hardware 203. As shown, a virtual computing system 206 may include a virtual machine 210, a container 211, or a hybrid environment 212 that includes a virtual machine and a container, among other examples. A virtual computing system 206 may execute one or more applications using a file system that includes binary files, software libraries, and/or other resources required to execute applications on a guest operating system (e.g., within the virtual computing system 206) or the host operating system 205.

Although the lifecycle management system 201 may include one or more elements 203-212 of the cloud computing system 202, may execute within the cloud computing system 202, and/or may be hosted within the cloud computing system 202, in some implementations, the lifecycle management system 201 may not be cloud-based (e.g., may be implemented outside of a cloud computing system) or may be partially cloud-based. For example, the lifecycle management system 201 may include one or more devices that are not part of the cloud computing system 202, such as device 300 of FIG. 3, which may include a standalone server or another type of computing device. The lifecycle management system 201 may perform one or more operations and/or processes described in more detail elsewhere herein.

The network 220 may include one or more wired and/or wireless networks. For example, the network 220 may include a cellular network, a public land mobile network (PLMN), a local area network (LAN), a wide area network (WAN), a private network, the Internet, and/or a combination of these or other types of networks. The network 220 enables communication among the devices of the environment 200.

The server device(s) 230 may include one or more devices capable of receiving, generating, storing, processing, and/or providing information, as described elsewhere herein. The server device(s) 230 may include a communication device and/or a computing device. For example, the server device(s) 230 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of the environment 200 may perform one or more functions described as being performed by another set of devices of the environment 200.

FIG. 3 is a diagram of example components of a device 300 associated with automated control of machine image lifecycle management. The device 300 may correspond to the lifecycle management system 201 and/or the server device 230. In some implementations, the lifecycle management system 201 and/or the server device 230 may include one or more devices 300 and/or one or more components of the device 300. As shown in FIG. 3, the device 300 may include a bus 310, a processor 320, a memory 330, an input component 340, an output component 350, and/or a communication component 360.

The bus 310 may include one or more components that enable wired and/or wireless communication among the components of the device 300. The bus 310 may couple together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 may include a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, or a combination of hardware and software. In some implementations, the processor 320 may include one or more processors capable of being programmed to perform one or more operations or processes described elsewhere herein.

The memory 330 may include volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 may store information, one or more instructions, and/or software (e.g., one or more software applications) related to the operation of the device 300. In some implementations, the memory 330 may include one or more memories that are coupled (e.g., communicatively coupled) to one or more processors (e.g., processor 320), such as via the bus 310. Communicative coupling between a processor 320 and a memory 330 may enable the processor 320 to read and/or process information stored in the memory 330 and/or to store information in the memory 330.

The input component 340 may enable the device 300 to receive input, such as user input and/or sensed input. For example, the input component 340 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 350 may enable the device 300 to provide output, such as via a display, a speaker, and/or a light-emitting diode. The communication component 360 may enable the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

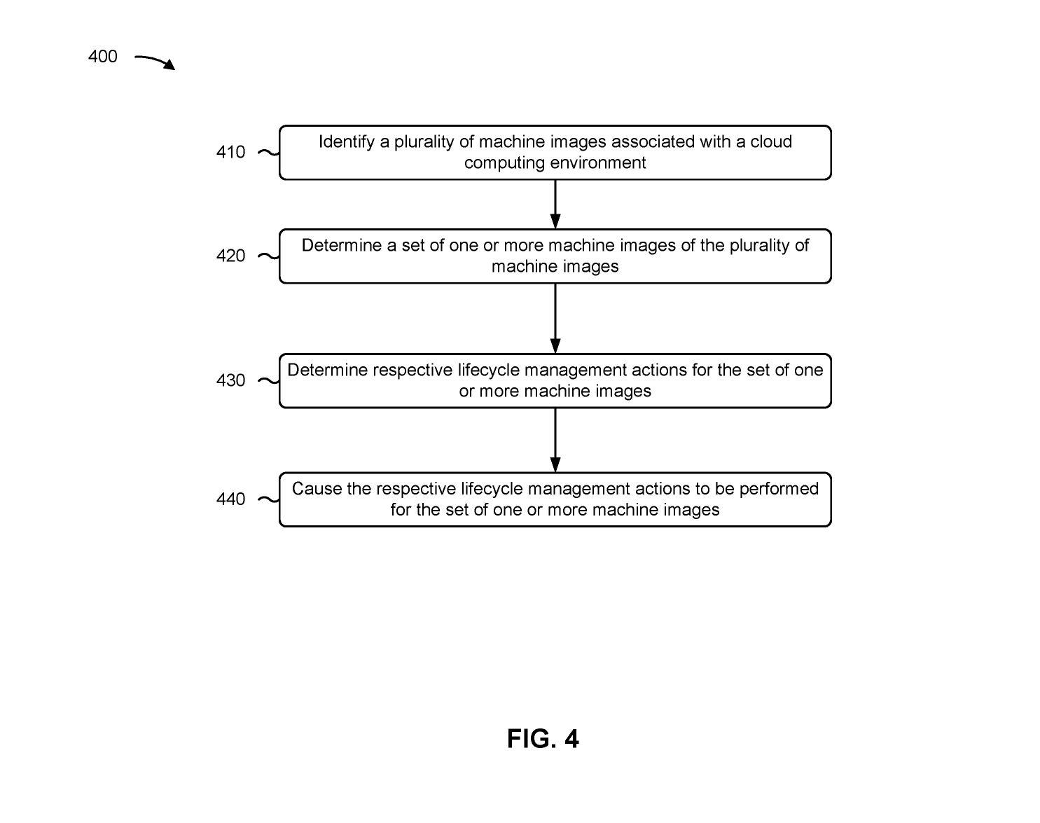

FIG. 4 is a flowchart of an example process 400 associated with automated control of machine image lifecycle management. In some implementations, one or more process blocks of FIG. 4 may be performed by the lifecycle management system 201. In some implementations, one or more process blocks of FIG. 4 may be performed by another device or a group of devices separate from or including the lifecycle management system 201, such as the network 220 and/or the server device(s) 230. Additionally, or alternatively, one or more process blocks of FIG. 4 may be performed by one or more components of the device 300, such as processor 320, memory 330, input component 340, output component 350, and/or communication component 360.

As shown in FIG. 4, process 400 may include identifying a plurality of machine images associated with a cloud computing environment (block 410). For example, the lifecycle management system 201 (e.g., using processor 320 and/or memory 330) may identify a plurality of machine images associated with a cloud computing environment, as described above in connection with reference number 102 of FIG. 1A.

As further shown in FIG. 4, process 400 may include determining a set of one or more machine images of the plurality of machine images (block 420). For example, the lifecycle management system 201 (e.g., using processor 320 and/or memory 330) may determine a set of one or more machine images of the plurality of machine images, as described above in connection with reference number 104 of FIG. 1A. As an example, the lifecycle management system 201 may filter the plurality of machine images using at least one of one or more filter parameters or respective tag information associated with the plurality of machine images.

As further shown in FIG. 4, process 400 may include determining respective lifecycle management actions for the set of one or more machine images (block 430). For example, the lifecycle management system 201 (e.g., using processor 320 and/or memory 330) may determine respective lifecycle management actions for the set of one or more machine images, as described above in connection with reference number 106 of FIG. 1B. As an example, the lifecycle management system 201 may determine the respective lifecycle management actions based on respective reference information associated with the set of one or more machine images.

As further shown in FIG. 4, process 400 may include causing the respective lifecycle management actions to be performed for the set of one or more machine images (block 440). For example, the lifecycle management system 201 (e.g., using processor 320 and/or memory 330) may cause the respective lifecycle management actions to be performed for the set of one or more machine images, as described above in connection with reference number 108 of FIG. 1B. As an example, the lifecycle management system may perform the respective lifecycle management actions, or alternatively, the lifecycle management system may cause another device to perform the respective lifecycle management actions.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel. The process 400 is an example of one process that may be performed by one or more devices described herein. These one or more devices may perform one or more other processes based on operations described herein, such as the operations described in connection with FIGS. 1A and 1B. Moreover, while the process 400 has been described in relation to the devices and components of the preceding figures, the process 400 can be performed using alternative, additional, or fewer devices and/or components. Thus, the process 400 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code - it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for machine image lifecycle management, the system comprising:
one or more memories; and
one or more processors, communicatively coupled to the one or more memories, configured to:
identify a plurality of machine images associated with a cloud computing environment;
determine, using at least one of one or more filter parameters or respective tag information associated with the plurality of machine images, a set of one or more machine images of the plurality of machine images;
determine, based on respective reference information associated with the set of one or more machine images, respective lifecycle management actions for the set of one or more machine images; and
cause the respective lifecycle management actions to be performed for the set of one or more machine images.

2. The system of claim 1, wherein each lifecycle management action, of the respective lifecycle management actions, includes one of:
a deregistration lifecycle management action,
a deprecation lifecycle management action, or
an access revocation lifecycle management action.

3. The system of claim 1, wherein the one or more processors, to identify the plurality of machine images, are configured to:
identify the plurality of machine images based on at least one of:
a periodic schedule, or
detection of a trigger event.

4. The system of claim 1, wherein the one or more processors, to determine the set of one or more machine images, are configured to:
identify a particular machine image of the plurality of machine images;
identify one or more attributes associated with the particular machine image; and
cause, based on the one or more filter parameters and the one or more attributes, the particular machine image to be one of:
included in the set of one or more machine images, or
not included in the set of one or more machine images.

5. The system of claim 1, wherein the one or more processors, to determine the set of one or more machine images, are configured to:
identify a particular machine image of the plurality of machine images;
identify particular tag information, of the respective tag information, that is associated with the particular machine image;
modify, based on the particular tag information, the one or more filter parameters;
identify one or more attributes associated with the particular machine image; and
cause, based on the modified one or more filter parameters and the one or more attributes associated, the particular machine image to be one of:
included in the set of one or more machine images, or
not included in the set of one or more machine images.

6. The system of claim 1, wherein the one or more processors, to determine the set of one or more machine images, are configured to:
identify a particular machine image of the plurality of machine images;
identity particular tag information, of the respective tag information, that is associated with the particular machine image; and
cause, based on the particular tag information, the particular machine image to be one of:
included in the set of one or more machine images, or
not included in the set of one or more machine images.

7. The system of claim 1, wherein the one or more processors, to determine the respective lifecycle management actions for the set of one or more machine images, are configured to:
identify a particular machine image of the set of one or more machine images;
identify particular reference information, of the respective reference information, that is associated with the particular machine image;
determine, based on the particular reference information, whether the particular machine image is actively used by at least one compute resource of the cloud computing environment; and
determine, based on determining whether the particular machine image is actively used, a particular lifecycle management action, of the respective lifecycle management actions, for the particular machine image.

8. The system of claim 7, wherein the one or more processors, to determine the particular lifecycle management action, are configured to:
determine, based on determining that the particular machine image is not actively used, a deregistration lifecycle management action as the particular lifecycle management action.

9. The system of claim 7, wherein the one or more processors, to determine the particular lifecycle management action, are configured to:
determine, based on determining that the particular machine image is actively used, one of a deprecation lifecycle management action or an access revocation lifecycle management action as the particular lifecycle management action.

10. A non-transitory computer-readable medium storing a set of instructions, the set of instructions comprising:
one or more instructions that, when executed by one or more processors of a system, cause the system to:
determine, using at least one of one or more filter parameters or respective tag information associated with a plurality of machine images associated with a cloud computing environment, a set of one or more machine images of the plurality of machine images;
determine, based on respective reference information associated with the set of one or more machine images, respective lifecycle management actions for the set of one or more machine images; and
cause the respective lifecycle management actions to be performed for the set of one or more machine images.

11. The non-transitory computer-readable medium of claim 10, wherein the one or more instructions, that cause the system to determine the set of one or more machine images, cause the system to:
cause, based on the one or more filter parameters and one or more attributes associated with a particular machine image of the plurality of machine images, the particular machine image to be one of:
included in the set of one or more machine images, or
not included in the set of one or more machine images.

12. The non-transitory computer-readable medium of claim 10, wherein the one or more instructions, that cause the system to determine the set of one or more machine images, cause the system to:
modify, based on particular tag information, of the respective tag information, that is associated with a particular machine image of the plurality of machine images, the one or more filter parameters; and
cause, based on the modified one or more filter parameters and one or more attributes associated with the particular machine image to be one of:
included in the set of one or more machine images, or
not included in the set of one or more machine images.

13. The non-transitory computer-readable medium of claim 10, wherein the one or more instructions, that cause the system to determine the set of one or more machine images, cause the system to:
cause, based on particular tag information, of the respective tag information, that is associated with a particular machine image, the particular machine image to be one of:
included in the set of one or more machine images, or
not included in the set of one or more machine images.

14. The non-transitory computer-readable medium of claim 10, wherein the one or more instructions, that cause the system to determine the respective lifecycle management actions for the set of one or more machine images, cause the system to:
determine, based on particular reference information, of the respective reference information, that is associated with a particular machine image, of the set of one or more machine images, whether the particular machine image is actively used by at least one compute resource of the cloud computing environment; and
determine, based on determining whether the particular machine image is actively used, a particular lifecycle management action, of the respective lifecycle management actions, for the particular machine image.

15. The non-transitory computer-readable medium of claim 14, wherein the one or more instructions, that cause the system to determine the particular lifecycle management action, cause the system to:
determine, based on determining that the particular machine image is not actively used, a deregistration lifecycle management action as the particular lifecycle management action.

16. The non-transitory computer-readable medium of claim 14, wherein the one or more instructions, that cause the system to determine the particular lifecycle management action, cause the system to:
determine, based on determining that the particular machine image is actively used, one of a deprecation lifecycle management action or an access revocation lifecycle management action as the particular lifecycle management action.

17. A method, comprising:
determining, by a system and based on respective reference information associated with a set of one or more machine images of a plurality of machine images associated with a cloud computing environment, respective lifecycle management actions for the set of one or more machine images; and
causing, by the system, the respective lifecycle management actions to be performed for the set of one or more machine images.

18. The method of claim 17, further comprising:
identifying a particular machine image of a plurality of machine images;
identifying at least one of one or more attributes associated with the particular machine image or particular tag information associated with the particular machine image; and
causing, based on the at least one of the one or more attributes or the particular tag information, the particular machine image to be one of:
included in the set of one or more machine images, or
not included in the set of one or more machine images.

19. The method of claim 17, wherein determining the respective lifecycle management actions for the set of one or more machine images comprises:
identifying a particular machine image of the set of one or more machine images;
identifying particular reference information, of the respective reference information, that is associated with the particular machine image;
determining, based on the particular reference information associated with the particular machine image, of the set of one or more machine images, whether the particular machine image is actively used by at least one compute resource of the cloud computing environment; and
determining, based on determining whether the particular machine image is actively used, a particular lifecycle management action, of the respective lifecycle management actions, for the particular machine image.

20. The method of claim 19, wherein determining the particular lifecycle management action comprises:
determining, based on determining whether the particular machine image is actively used, the particular lifecycle management action as one of:
a deregistration lifecycle management action,
a deprecation lifecycle management action, or
an access revocation lifecycle management action.
